(19) United States
(12) Patent Application Publication
(10) Pub. No.: US 2004/0026252 A1
(43) Pub. Date: Feb. 12, 2004

(54) Extended pathlength detection in separations

(76) Inventor: Qingbo Li, State College, PA (US)

Correspondence Address: PENNIE & EDMONDS LLP, 1667 K STREET NW, SUITE 1000, WASHINGTON, DC, 20006

(21) Appl. No.: 10/347,187

(22) Filed: Jan. 21, 2003

Related U.S. Application Data
(63) Continuation of application No. PCT/US01/23051, filed on Jul. 23, 2001.
(60) Provisional application No. 60/219,690, filed on Jul. 21, 2000.

(51) Int. Cl. G01N 27/27

(52) U.S. Cl. 204/603

(57) ABSTRACT

The present invention relates to a separation apparatus for the separation and detection of components of a sample. The apparatus includes at least one separation lane suitable for at least partially separating the sample components along a separation direction. A light source configured to emit light suitable to interact with the sample components is disposed in optical communication with the separation lane. Light from the light source enters the separation lane at a light entry point therealong. At least some of the light that enters the separation lane exits the separation lane at a light exit point. The light exit point is spaced apart from the light entry point along the separation direction. A light detector detects the light exiting the separation lane.

### RELATED APPLICATIONS

The present application is a continuation of international application number PCT/US01/23051, filed Jul. 23, 2001, which application is based on U.S. provisional application No. 60/219,690, filed Jul. 21, 2000, both of which applications are incorporated herein by reference.

### FIELD OF THE INVENTION

The present invention relates to a method and apparatus for detecting components of a sample. More particularly, the invention relates to a method and apparatus for increasing the pathlength in optical detection to facilitate detection of sample components in separations.

### BACKGROUND

Capillary electrophoresis (CE), including capillary zone electrophoresis (CZE) and capillary gel electrophoresis (CGE), is gaining more popularity as a powerful separation technology. This is largely due to the impressive benefits that CE provides, including the high-efficiency separation of large variety of compounds, such as amino acids, peptides, proteins, polymerase chain reaction (PCR) products, oligonucleotides, carbohydrates, vitamins, organic acids, polymers, chiral drugs, dyes, surfactants, and the like. In addition, CE represents a separation platform that is highly suitable for massively multiplexing and efficiently automating most of the separations typically attained by labor-intensive slab gel electrophoresis to reduce the time required to obtain results from hours to minutes. Separated components are quickly identified by online detectors during the analysis, in contrast to the time-consuming staining steps required for slab gel separations.

Absorption detection using light in the ultraviolet-visible (UV-Vis) range is among the most frequently used detection methods in chromatography (HPLC and CE) due to its universal detection capability. Detection is achieved by monitoring absorbance or attenuation of excitation light directly online through a window in the capillary. With fused-silica capillaries, wavelengths below 200 nm and up through the visible spectrum can be used.

In high performance CE, a capillary bore, which provides a separation lane, usually has an internal diameter (ID) of about 10 to 200 μm, and a typical outer diameter (OD) of about 100-500 μm. Because the small internal diameter provides a small path length, detection sensitivity is usually lower in CE than in conventional UV absorption spectrometer where the sample cell has relatively longer light pathlength. It is understood in the art that the absorbance A=εbc is proportional to the pathlength b, the sample concentration c, and the extinction coefficient of the sample component ε.

Sensitivity can be enhanced by using capillaries with an extended light path transverse to the longitudinal bore of the capillary. These capillaries, such as the HP 3D Capillary Electrophoresis system produced by the Hewlett-Packard Co., Palo Alto, Calif., contain an expanded-diameter section at the point of detection, reportedly increasing sensitivity three-fold over straight capillaries. This approach, however, can not be easily implemented for multiplexing capillary electrophoresis system.

An absorption detection approach for multiplexed CE has been disclosed by X. Gong and E. S. Yeung (Anal. Chem. 1999, 71, 4989-4996). A linear photo diode array (LPDA) is used to measure light transmitted across the internal diameter of capillaries configured in an array. In this approach, the lightpath is transverse to the separation channel of each capillary in the array. Thus, the lightpath is limited by the actual, very short, internal diameter of the capillary. The large saturation charge for each diode in the LPDA allows a relatively high illumination light level to help reduce the noise, but the LPDA does not provide spectral information relating to the wavelength dependent absorbance of the sample components.

### SUMMARY OF THE INVENTION

The present invention relates to an apparatus for detecting the components of a sample. Preferably, the apparatus is a separation apparatus including at least one separation lane suitable for at least partially separating the sample components along a separation direction. A light source is configured to emit light suitable to interact with the sample components. The apparatus is preferably configured such that the light enters the separation lane at a entry point therealong and exits the separation lane at a light exit point. Preferably, the light exit point is spaced apart from the entry point along the separation direction, which is preferably aligned with a longitudinal axis of the separation lane. The term “point” is used to describe the regions where light enters and exits the separation channel because the dimensions of the entry points and light exit points are preferably substantially smaller than the distance spacing apart the entry and light exit points. A light detector detects the light exiting the separation lane to obtain determine the presence of the sample components. In a preferred embodiment of the invention, a two-dimensional array detector (a CCD or CID) is used to monitor an array of separation lanes to facilitate detection of spectral information for each separation lane in the array.

In a preferred embodiment, the apparatus includes a computer configured to process signals related to the light detected by the detector. Preferably, the interaction of the light with the sample components in the separation lane attenuates the light and the signals from the detector relate to the degree of light attenuation.

The emitted light includes at least one wavelength and the detector is configured to be responsive to the at least one emitted wavelength. In a preferred embodiment, the emitted light has a plurality of wavelengths and the signals relate to the degree of attenuation of at least two of the emitted wavelengths. More preferably, detector and light source are configured to obtain an absorbance spectrum of the sample components and the signals relate to the absorbance spectrum.

In another preferred embodiment, the apparatus comprises a plurality of separation lanes and the detector is configured to detect light exiting from respective separation lanes. More preferably, the plurality of separation lanes are an array of capillaries or an array of channels in a microfabricated separations device.

In another embodiment, the light enters the separation channel at angle of from about 10 to 90 degrees, more preferably from about 20 to 75 degrees, most preferably from about 30 to 60 degrees with respect to the longitudinal axis of the separation channel. The light preferably changes direction at least twice before exiting the separation lane. Each change in direction is preferably caused by waveguiding behavior of the light such as an internal reflection of the light at an internal surface of the separation lane. An example of an internal surface is the boundary between a capillary bore and a running buffer or sieving matrix used to support the separation. Preferably, the internal reflection does not occur by total internal reflection. If total internal reflection were to occur, light would not emerge from the light exit point through the wall of the capillary. Rather, the light would be totally reflected back into the separation. Thus, it is preferred that, upon each internal reflection, that some of the light impinging upon the wall of the capillary enter the wall and some be reflected back into the separation lane.

Particles, such as micelles or silica particles used to support a stationary phase, can scatter the light. As used herein, the term particles does not include sample substances, such as proteins or DNA molecules, to be separated. According to one embodiment of the present invention, the amount of such scattered light that reaches the detector is substantially less than the amount of light that reaches the detector without having been scattered by such particles. For example, of light that enters the separation lane at the entry point and exits at the light exit point, less than about 25%, preferably less than about 10% and more preferably less than about 2% is scattered from particles present in the separation lane. In a most preferred embodiment, such scattering of the light is essentially eliminated.

To reduce the amount of light scattered, the separation lane between the entry point and the light exit point is preferably essentially free of particles used to support a stationary phase. Such particles are used, for example, in capillary electro-chromatography, which uses an electric potential to move solvent and sample components through a separation lane packed with particles having a stationary phase, such as an alkane or other organic molecule. If particles are present in the separation lane between the entry point and light exit point, the average size of the particles is at least 50%, preferably at least 75%, and more preferably at least about 95% smaller than the wavelength of the light. Preferably, the separation lane is essentially free of any particles larger than about 1% of the wavelength.

The separation lane has a minimum dimension transverse to the longitudinal axis. Examples of minimum transverse dimensions include a diameter of a capillary bore and a width or height of a channel microfabricated in a substrate. A distance along the separation lane longitudinal axis between the entry point and the light exit point is at least about five times, preferably at least about ten times, and most preferably at least about 100 times greater than the minimum transverse dimension.

Another embodiment of the present invention relates to an apparatus for processing signals or data indicative of a separation of components of a sample. For example, the processor may be associated with a computer, which receives the data from a detector used to detect the separation of the sample components. The apparatus can be in direct communication with the detector or the data can be received remotely. The data is representative of components separated along a separation lane having a separation direction, wherein light from a light source enters the separation lane at a entry point therealong and exits the separation lane at a light exit point. The light exit point and the entry point are spaced apart from one another along the separation dimension that was used to separate the sample components.

A processor is configured to receive a plurality signals from a detector. A first portion of the signals results from the light that exited the separation lane, preferably after the light has been attenuated by interacting with at least one sample component present in the separation lane. A second portion of the detector signals result from light that is indicative of the amount of light that entered the separation lane. By indicative of the amount of light that entered the separation lane, it is meant that the second portion of detector signals can be used as a reference to determine the amount of attenuation of the light exiting the separation lane. Preferably, the light that is indicative of the amount of light entering the separation lane is directly proportional to the amount of light entering the separation lane. The processor is configured to distinguish between the first and second detector signals. Preferably, the processor determines an absorbance based upon the first and second detector signals.

Another embodiment of the present invention relates to a separation apparatus for separating components of a sample. The apparatus includes at least one capillary defining a capillary bore having a light entry point and a light exit point spaced apart from the light entry point along a separation direction. The capillary bore is suitable for at least partially separating the sample components along the separation direction.

A light source is configured to emit light suitable to interact with the sample components. The apparatus may include at least one of a light focusing element and a light steering element to focus and or direct the light through a wall of the capillary and into the capillary bore at a light entry point along the capillary. The focusing element and/or light steering element may be configured to direct the light through the light entry point so that the light enters the capillary bore at an angle of at least about 20° with respect to the separation direction. The angle may be less than about 70. At least some of the light that enters the light entry point passes generally along the capillary bore between the light entry and light exit points by partial reflections at a surface of the capillary bore and exits the capillary bore at the exit point.

The apparatus includes a light detector configured to detect the light exiting the capillary bore.

### BRIEF DESCRIPTION OF THE FIGURES

The present invention is described in detail below with reference to the following figures in which:

FIGS. 1a and 1b show partial views of a separation lane according to the invention;

FIGS. 2a and 2b show end on views of separation lanes of the invention;

FIG. 3 shows an embodiment of an apparatus according to the invention;

FIGS. 4a and 4b show views of a separation lane according to the invention showing the presence of a sample component;

FIG. 5 illustrates a partial view of a separation lane showing the increased pathlength that is obtained according to the invention;

FIG. 6 shows an embodiment of an apparatus having a plurality of separation lanes according to the invention;

FIG. 7a shows a partial view of two separation lanes of the apparatus of FIG. 6;

FIG. 7b shows a schematic of imaging light from the separation lanes of FIG. 7a onto a detector array;

FIG. 8 shows an embodiment of an apparatus according to the invention with light passing between adjacent capillaries of an array.

FIG. 9 shows another embodiment of an apparatus according to the invention with light exiting an end of the separation lane;

FIG. 10 shows an embodiment of an apparatus according to the invention with light exiting the ends of each of a plurality of separation lanes;

FIGS. 11a and 11b show an embodiment of an apparatus according to the invention with light exiting an end of the separation lane with an optical cell configured to improve detection efficiency;

FIG. 12 shows an embodiment of a microfabricated separation lane of the invention;

FIG. 13 shows a close up of the separation lane of FIG. 12;

FIG. 14 is a side view of FIG. 13; and

FIG. 15 shows an embodiment of the invention having multiple detection options.

### DETAILED DESCRIPTION OF THE PREFERRED EMBODIMENTS

The present invention relates to absorption detection of sample components migrating along a separation lane, which is preferably configured to support an electric field-based separation technique. An internal bore of a capillary electrophoresis column provides a preferred separation lane. A light enters the separation lane at a entry point and exits the separation lane at a light exit point. The light entry point and light exit point are preferably spaced apart from one another along a longitudinal axis of the separation column. A distance between the entry and light exit points along the longitudinal axis is preferably substantially longer than an internal transverse dimension of the separation channel. Thus, the present invention provides a longer detection pathlength than methods where light passes transversely through the separation lane. Attenuation of the excitation light passing along the separation channel is monitored to determine the presence and abundance of substances present in the separation lane between the entry and light exit points. Thus, in contrast to fluorescence measurements, which seek to prevent an excitation light from a light source from reaching a detector, the present light attenuation measurements seek to detect light that enters the separation lane from the light source.

Electric field-based separation techniques suitable for use with the present invention include any technique in which molecules and/or fluids are manipulated and/or separated using electric fields, such as capillary zone electrophoresis, isoelectrophoresis, gel electrophoresis, electrophoretic chromatography using open or packed channels, micellar electrophoresis, and isotachophoresis. Some embodiments of electrophoresis, such as gel electrophoresis, require that the channels be filled with a gel, which can be a sieving matrix. On the other hand, capillary zone electrophoresis can be carried out using only a fluid solvent/buffer medium to fill the channels. The present invention is equally adaptable to all such embodiments of electrophoresis. It is understood in the art that the electrophoresis channels are preferably in electrical contact, such as by a wire, conductive solution, or other electrically conducting medium, to an electrical power supply, which applies a sufficient electric field along the channel to achieve a separation of the sample components. Additionally, the separation channel is preferably configured, as understood in the art, to allow the introduction of a sample and separation medium into the separation channel.

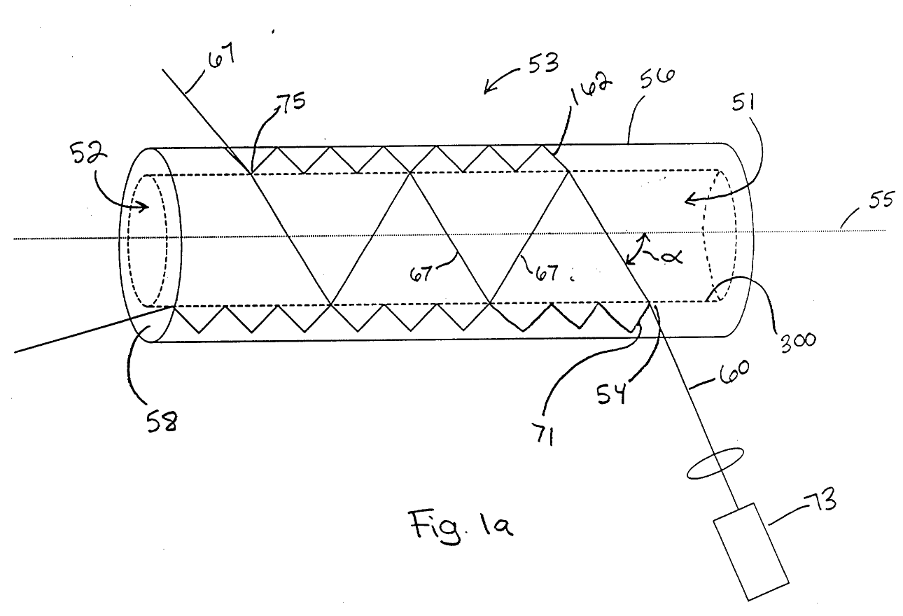

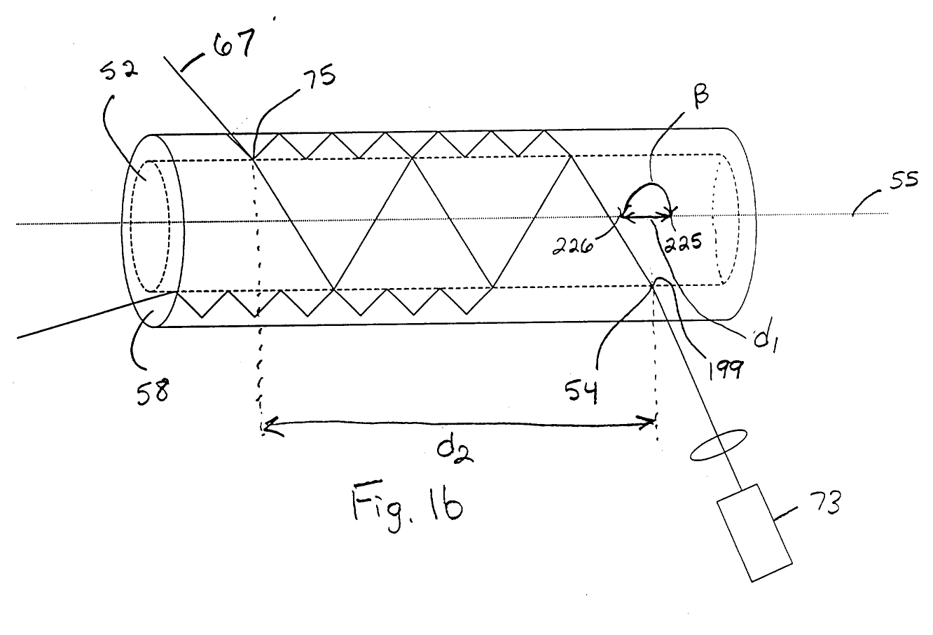

Referring to FIGS. 1a and 1b, a first embodiment of the present invention preferably includes at least one separation lane 51 suitable for at least partially separating components of a sample along a separation direction. The terms lanes or channels are used synonymously herein and refer generally to any volume or space configured to support the separation of sample components based upon a physical and/or chemical property of the components, such as a charge, size, shape, polarity, or combination thereof. In a preferred embodiment, separation lane 51 is defined by the internal bore 52 of a capillary, such as a capillary bore of a capillary, such as a silica capillary 53 suitable for separating sample components in the presence of an electric field. Typically, the internal bore runs along a longitudinal axis 55 of the capillary 53 and, during separation, the components preferably translate or migrate substantially along longitudinal axis 55. In one embodiment the separation lane is a unitary capillary, preferably without breaks or junctions between the light entry point and the light exit point. In another embodiment, the unitary capillary is configured without breaks or junctions between the point at which samples are injected and the light exit point. In one embodiment, a surface of the internal bore of the capillary defining the separation lane is free of a conductive coating between the light entry point and the light exit point. For example, the surface of the internal bore may be free of a metallic coating between the light entry point and light exit point.

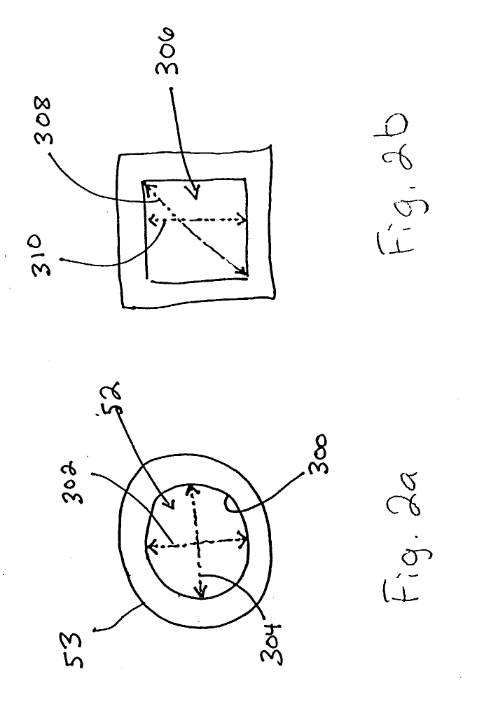

As seen in FIG. 2a, a preferred bore geometry of internal bore 52 is substantially circular. A surface 300 of internal bore 52 defines a boundary between capillary 53 and a separation medium, such as a running buffer, within the bore. By substantially circular it is meant that the ratio of a longest transverse internal dimension 302 of the bore to a minimum transverse internal dimension 304 of the bore is about 1. Preferably the ratio is less than about 1.2, and preferably less than 1.1. One possible geometry is an elliptical internal bore having a major axis diameter to minor axis diameter ratio of less than about 1.2. An alternative separation lane has an internal bore 306 having a square geometry, FIG. 2b. For the square geometry, a ratio of a longest transverse internal dimension 308 to a minimum transverse internal dimension 310 is about 1.4, and more precisely, approximately 2^{1/2}.

In one embodiment, the surface of the internal bore is essentially free of a reflective coating. Thus, the internal bore between the light entry points and exit points may be essentially free of a metallic or other reflective coating. In this embodiment, light passing along the internal bore experiences partial internal reflections at the interface between the separation medium and the capillary wall rather than an interface between the separation medium and a reflective coating.

The internal diameter of the separation lane is substantially constant between the entry and light exit points. Preferably, the internal diameter varies by less than about 25%, more preferably less than about 15%, and more preferably by less than about 5% between the entry and light exit points.

Returning to FIG. 1a, a light source 73 is optically associated with the apparatus of the present invention to provide light having at least one wavelength suitable for interacting with the sample components. As discussed below, the interaction preferably results in an attenuation of the light, which attenuation can be used to determine the presence or absence of sample components in the separation lane between the entry and light exit points. The at least one wavelength is preferably in the range of about 170 nm to about 750 nm. Light source 73 may be an incoherent light source, such as a mercury lamp, or a coherent light source, such as laser emitting visible and/or ultraviolet light.

During a separation, excitation light 60 is directed toward a entry point 54, through a wall 58 of capillary 53, and into separation lane 51. With respect to longitudinal axis 55 of capillary 53, the entry point is defined as the location along the axis where the light first passes through an interface 199 between the capillary wall 58 and the separation medium within the bore of the capillary.

The outer surface of capillary 53 at entry point 54 is preferably configured to facilitate efficient coupling of light 60 into separation lane 51. For example, the outer surface at entry point 54 may be formed by a cylindrical exterior surface 56 of capillary 53. Alternatively, exterior surface 56 may be modified, such as by grinding or otherwise forming a flat portion, at entry point 54. Yet another alternative comprises the use of an auxiliary optic such as a prism, waveguide, or grating suitable for directing light into separation lane 51. When a prism is used, it is preferred that the prism be optically coupled to the entry point via a refractive index matching fluid to improve the efficiency of introducing light into the separation lane. In yet another alternative, an optic, such as a microscope objective or lens 65, may be used to focus the light to facilitate the light entering entry point 54.

Substantially all of the light preferably enters separation channel at an angle (α) with respect to the longitudinal axis 55 of the separation channel. At least about 60%, preferably at least about 75%, more preferably at least about 85%, and most preferably at least about 95% of the light enters at angle (α). Thus, less than about 25% of the light enters the separation lane at less than angle (α) with respect to the longitudinal axis. Angle (α) is sufficiently small to allow a portion of the light to propagate along the separation channel but sufficiently large to allow efficient coupling of the light into the channel. Angle (α) is at least 10°, preferably 20°, and most preferably 30° with respect to the longitudinal axis 55 or separation direction. Angle (α) is less than about 90°, preferably less than 75°, and most preferably less than about 60° with respect to the longitudinal axis 55 or separation direction.

To reduce broadening of sample component bands produced by bends in the separation lane, longitudinal axis 55 is preferably substantially straight between an upstream point 225 disposed upstream from entry point 54 and a downstream point 226 disposed downstream from entry point 54, as shown in FIG. 1b. Upstream point 225 and downstream point 226 are preferably disposed an equal distance from point 54 along longitudinal axis 55. A ratio of a distance d₁, which separates points 225 and 226 along longitudinal axis 55, to a distance d₂, which separates entry and light exit points 54 and 75 along longitudinal axis 55 is preferably less than about 2, more preferably less than about 1. In one embodiment, point 225 is disposed about 2 mm upstream from entry point 54 and point 226 is disposed about 2 mm downstream from entry point 54. An angle (β) between points 225 and 226 is at least about 100°, preferably at least about 130°, and more preferably at least about 160°. Angle (β) preferably has a maximum of about 180°.

Upon entering separation lane 51, at least a portion of the light 67 propagates generally along longitudinal axis 55 toward a light exit point 75. Preferably, the light propagation includes internal reflections at interfaces between the separation medium in the capillary and an internal surface 300 of capillary wall 58. Before exiting the separation lane, light 67 preferably changes direction at least twice, by an internal reflection at an interface between internal bore surface 300 and a fluid in the separation lane.

Although it is preferred that the light from the light source enters the separation channel at an angle of less than about 90° with respect to the separation channel, it should be understood that a 90° angle may be used with the present invention. For example, even if the light enters the separation channel at an angle of 90° with respect to the separation channel, a portion of the light will propagate, such as by scattering, along the separation lane toward the light exit point. Therefore, such light will exit through the light exit point and can be detected to perform an absorbance measurement based on the attenuation of the light by sample components present in the separation lane.

Light exit point 75 is preferably provided and configured to facilitate at least a portion of the light emerging from the capillary. If capillaries with a coating are used, entry point 75 may comprise a region of the capillary where a slot-shaped portion of the coating has been removed to allow light to pass from within the internal bore of the capillary, through the wall 58, and toward a detector. An optical slit may also be used to facilitate defining light exit point 75 with respect to the longitudinal axis 55 of the capillary.

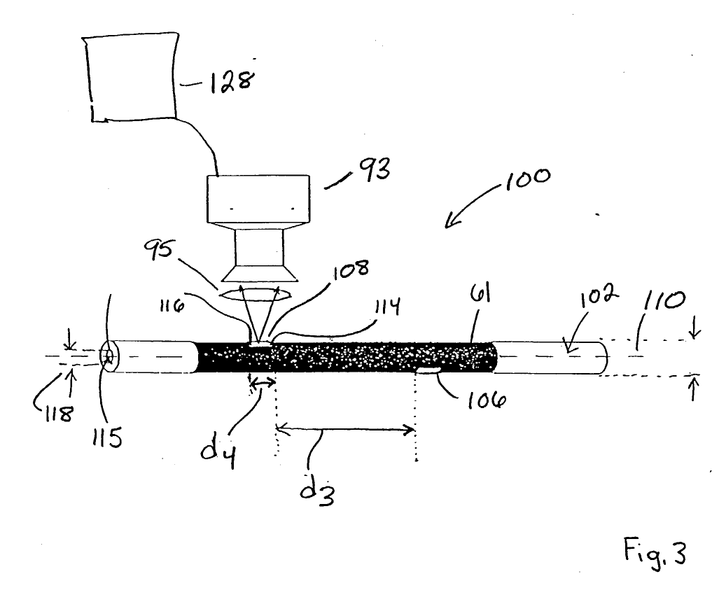

Referring to FIG. 3, an embodiment of an apparatus 100 having a capillary 102 having an internal bore 115 is shown. Capillary 102 includes a light entry point 106 and a light exit point 108. The dimensions of light entry and light exit points 106 and 108 are preferably substantially smaller than a distance d₃ along a longitudinal axis 110 of capillary 102 between the light entry and light exit points. For example, a longitudinal distance d₄ between a first edge 114 and a second edge 116 of light exit point 108 is preferably less than about 15%, more preferably less than about 10%, and most preferably less than about 5% of distance d₃. Distance d₄ preferably ranges from about 5 microns to about 5 mm depending on the distance between the light entry and light exit points. A transverse dimension of the light entry and light exit points is preferably defined by an internal transverse dimension of the separation lane. The light entry and light exit points preferably have similar dimensions.

Distance d₃ between the light entry point and light exit point is preferably greater than a minimum transverse dimension of the separation lane. An example of a minimum transverse dimension is inner diameter of the separation lane. Distance d₃ is preferably at least about five times, more preferably at least about ten times, and most preferably at least about one-hundred times greater than the minimum transverse dimension of the separation lane. For example, the distance between the light entry point and the light exit point is preferably from about 0.0025 cm to 10 cm depending on the inner diameter of the capillary or separation lane. In a preferred embodiment, the separation lane is the internal bore of a capillary and the distance between the light entry point and light exit point is about 7 mm to about 13 mm, such as about 10 mm.

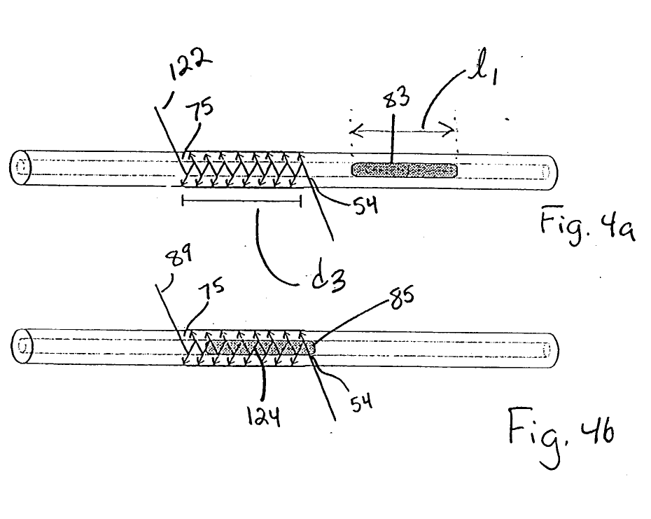

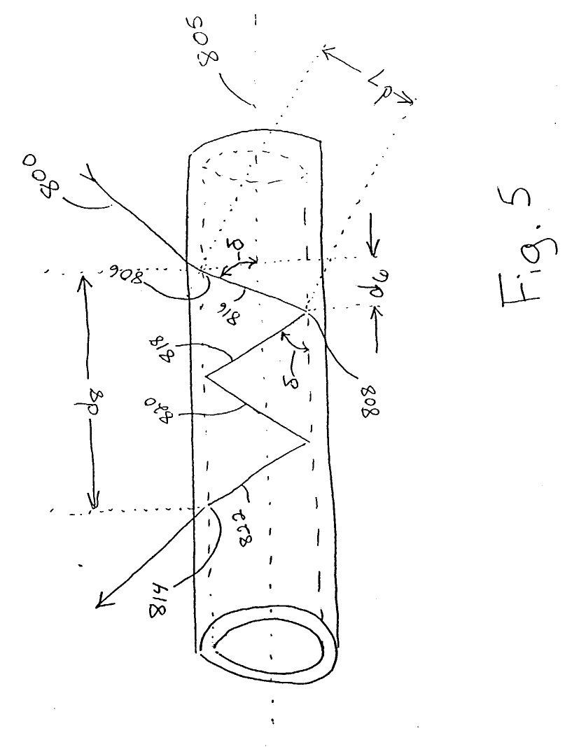

Referring to FIGS. 4a and 4b, the interaction of light with sample components present in between the light entry and light exit points of an apparatus of the invention is shown. In FIG. 4a, light 122 is shown emerging from light exit point 75 without having interacted with a sample component 83, which has not reached the light entry point 54 in FIG. 4a. Upon a sample component 85 passing between light entry and light exit points 54, 75, light 84 in the sample channel interacts 124 with sample component 85 before emerging from light exit point 75, as seen in FIG. 4b. Preferably, the presence of sample component 85 sufficiently attenuates light 84 propagating along the channel such that the amount of light 89 emerging from the capillary can be distinguished, such as by an absorbance measurement, from the amount of light, which emerges when no sample component is present. It should be understood that the role of light entry and light exit points 54, 75 can be reversed such that light enters downstream from where it exits the capillary.

Distance d₃ is not so large as to substantially reduce the separative resolution of the separation channel. Preferably, distance d₃ is less than about three times and more preferably less than about two times a length l₁ of separated sample component 83 reaching light entry point 54. In a most preferred embodiment, distance d₃ is about no larger than a length of a sample component reaching light entry point 54.

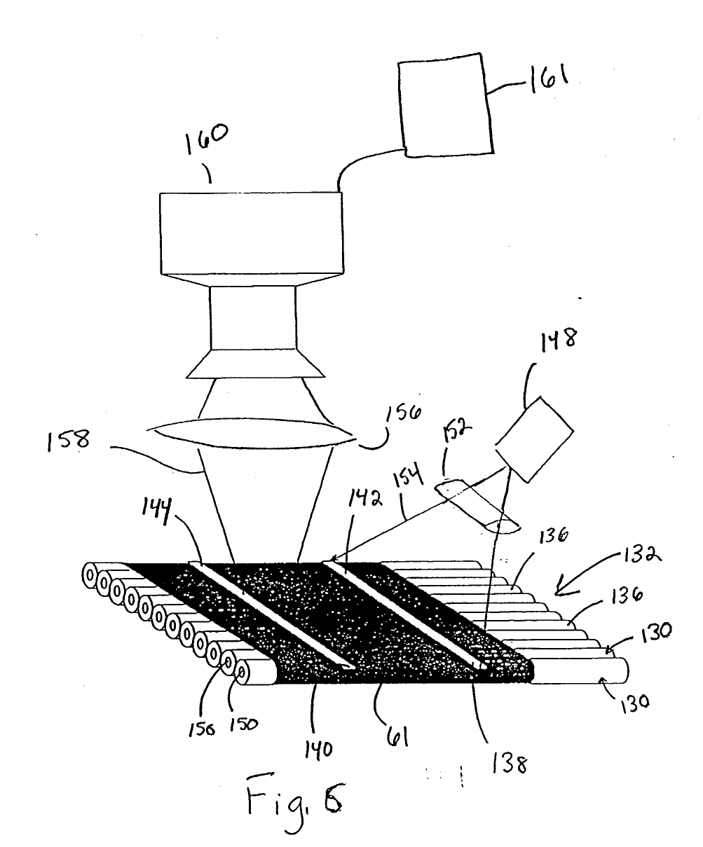

It should be understood that distance d₃ between light entry and light exit points 54, 75 defines the minimum pathlength along the separation axis for the light propagating along the separation lane. Internal reflections of the light within the separation lane increase the effective pathlength of the light without degrading resolution because the reflections do not increase the pathlength of the light along the separation axis. The effective path length is a function of the angle with respect to the longitudinal axis of the separation lane at which the light enters the separation lane. Referring to FIG. 5, light 800 enters a separation lane 802 at a light entry point 806 of a capillary 804. Light 800 enters at an angle δ with respect to a longitudinal axis 805 of separation lane 802.

Light propagates by internal reflection in successive pathlength segments 816, 818, 820 and 822 until it reaches light exit point 814, where light 800 emerges from the capillary. Because each segment is oriented at an angle to the longitudinal axis, the sum of the lengths of the successive segments exceeds a distance d8 between light entry point 806 and light exit point 814. Consider segment 816 between light entry point 806 and a point 808, which is also on an interior surface 810 of capillary 804. In proceeding along segment 816, light 800 travels a distance d₆ along longitudinal axis 800. However, distance d6 is less than a distance d₇, which is the length of segment 816 and the effective distance traveled by light 800 in proceeding from light entry point 806 to point 808. The effective pathlength (Pₑ) traveled by light 800 in propagating from light entry point 806 to light exit point 814 is given by Pₑ=d₈/cos (δ), where d₈ is the distance along the longitudinal axis between the light entry point and the light exit point. According to the present invention, Pₑ is about 2% for an angle of 10°, preferably about 10% for an angle of about 25°, and more preferably about 15% for an angle of about 30°, greater than d₈.

Referring back to FIG. 3, a detector 93 is used to detect the light emerging from the capillary to facilitate detection of the sample components. Detector 93 is any light sensitive device configured to detect light and output signals related to one or more of the amount, intensity, or wavelength of light incident upon the detector. Detector 93 is sufficiently sensitive to the wavelength of light emitted by the light source to facilitate absorbance detection. The apparatus is configured such that a sufficient amount of the light from the light source that enters the separation channel and propagates along the separation channel is incident upon the detector 93 to determine the attenuation of the light by a sample component. A computer 128 is preferably operably connected to detector 93 to receive and process the signals.

A lens 95 is preferably used to provide spatial discrimination to collect light emerging from the desired light exit point rather than from other points along or transverse to the separation lane, as discussed below. Thus, lens 95 may be used in the absence or in addition to a coating 61 or other structure to prevent light exiting the capillary away from the light exit point from reaching the detector, as described below. In a preferred embodiment, detector 93 is a two dimensional detector, such as a charge coupled device (CCD) or charge injection device (CID), and the detector includes optics such as a lens and wavelength selective optics to obtain a spectrum of the light emerging from the separation channel.

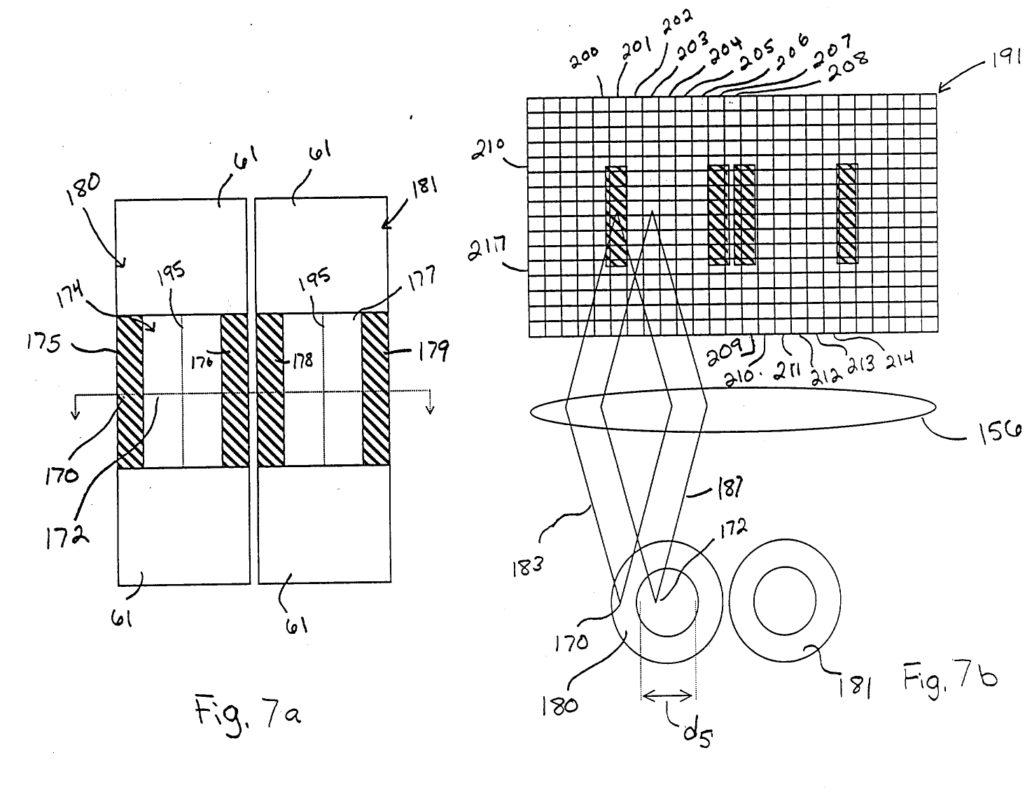

Referring to FIG. 6, a plurality of capillaries 130 are disposed in an array 132 such that a single sample can be simultaneously analyzed a plurality of times or a plurality of samples can simultaneously be analyzed. For example, U.S. Pat. No. 5,916,428 to Kane et al. and U.S. Pat. No. 6,027,627 to Li et al., which are hereby incorporated by reference to the extent necessary to understand the present invention, disclose automated electrophoretic systems employing a capillary cartridge having a plurality of capillary tubes. A first array of the one end of the capillaries are spaced apart in substantially the same manner as the wells of a microtitre tray. Samples provided in the wells can be introduced into the capillaries. Therefore, a plurality of samples can be simultaneously separated using electrophoresis in the array of capillaries.

Each capillary 130 includes a light entry point 138 and a light exit point 140, which are spaced apart from a proximal portion 136 of each capillary, where a separation is initiated. Within array 132, the light entry and light exit points are preferably configured so that light entry points 138 form a light entry point strip 142 and light exit points 140 form a light exit point strip 144 across the array of capillaries. To introduce light from a light source 148 into separation lanes 150 of capillaries 130, a lens, such as a cylindrical lens 152, is used to shape a light beam 154 to substantially match light entry strip 142 so that the light can be introduced into all of the separation lanes of the array. Subsequent to propagating along the separation lanes, a light 158 emerging from exit strip 144 is preferably detected by a detector 160, which communicates with a computer 161. A lens 156, such as a cylindrical lens, is preferably used to direct the light onto the detector to provide spatial discrimination.

Returning to FIG. 1, not all of light 60 that impinges upon light entry point 54 enters into separation lane 51. Thus, an amount of light 71 is typically reflected back into wall 58 upon encountering the boundary between wall 58 and the separation lane. Additionally, an amount of light 162 that does enter separation lane 51 reenters wall 58 upon encountering the boundary between the separation lane and wall 58. Because light 71 and light 162 do not propagate within the separation lane, they will remain substantially unattenuated by the presence of samples passing between the light entry and light exit points. Light that remains substantially un-attenuated by samples in the separation lane is stray light and contributes to nonlinear absorbance measurements. Thus, the amounts of light 71 and 162 that reach the detector are preferably minimized.

Referring to FIGS. 3 and 6, an outer surface of each of capillary 102, 130 is preferably in optical communication with means to prevent stray light 71 and 162 from reaching the detector. For example, a coating or other absorbing material, such as black paint 61, is optically associated with an outer surface of each capillary to attenuate the light that reaches the coating. Preferably, the coating material does not emit a sufficient amount of fluorescence upon absorbing the light to interfere with the detection of sample components. A small section of the coating is absent at each light entry and light exit point to provide a translucent window for light to enter or exit the separation lanes of the capillaries.

As an alternative or complement to a coating, the external wall of the separation lane may be encased within a structure having a dark absorbing surface, such as a mass of anodized metal having a groove shaped to accommodate outer surface of capillary. The structure preferably has apertures or slits configured to provide light entry and light exit points at desired locations. As another alternative, the outer surface of each capillary may be contacted with a medium that has a sufficiently similar refractive index to the capillary wall 58 to prevent a substantial reflection at the interface between the contacting medium and the capillary outer surface. By preventing the reflection, light propagates away from the capillary rather than reentering the capillary wall.

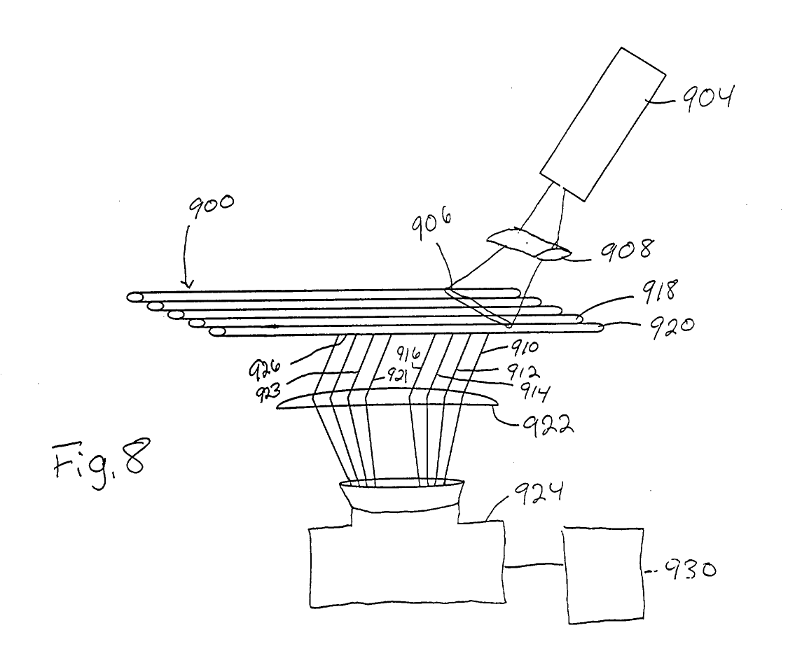

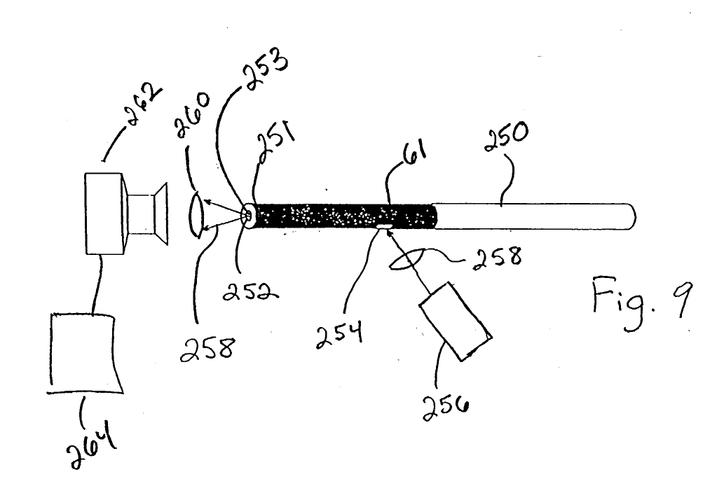

As an additional or alternative step to reducing stray light that reaches the detector, an imaging optic can be used to spatially discriminate light that exits the separation lane through a light exit point from light that remains substantially un-attenuated by the presence of samples in the separation lane. Referring to FIGS. 7a and 7b, an example of the use of a lens to provide spatial discrimination is shown. In FIG. 7a, a close up view of light exit point portions a first and second capillary 180 and 181 of array 132 of capillaries 130 is shown. First capillary 180 has a light exit point 174 and second capillary 181 has a light exit point 177. Each separation lane defines a longitudinal axis 195. A longitudinal dimension of light exit points 174 and 177 is defined by removed portions of coating 61 in optical contact with upstream and downstream portions of each capillary. A transverse dimension d₅ of light exit point 174 is defined by first and second capillary walls 175, 176. A transverse dimension of light exit point 177 is defined by first and second capillary walls 178, 179.

As discussed above, stray light can propagate through walls of the capillaries without substantially interacting with sample components present in the separation lane. For example, stray light 183 may originate from a point 170 in wall 175 of capillary 180. In contrast, a light 187 originates from a point 172 within the separation lane of capillary 180. A lens 190 images lights 183 and 187 onto an array 191 of rows and columns of light sensitive detector 160. The terms rows and columns are used for convenience only and are not intended to limit the configuration of the detector elements. For example, light arising from wall 175 is imaged onto detector elements running down columns 200, 201, and 202 in rows 210 through 217. Similarly, light arising from wall 176 is imaged onto detector elements running down columns 206-208 in rows 210 through 217. Light arising from light exit point 174 is imaged onto detector elements running down columns 202-206 in rows 210 through 217. Preferably, light from a transverse dimension of each light exit point is imaged across from about 3 to about 10, and more preferably about 4 or 5 columns of detector elements.

Columns 200-202 and 206-208 include light arising from walls 175 and 176, respectively. Therefore, detector signals from elements in these columns are preferably not included in measuring the amount of light that has propagated through the separation lane. Computer 161 preferably includes a processor configured to discriminate detector signals arising from detector elements that have received light that originates from the walls of a separation lane from detector signals arising from detector elements that have received only light that has propagated through a separation lane interacting with sample components therein.

A first step in performing an absorbance measurement is to determine which detector elements receive only light arising from walls 175 and 176. One way to accomplish this is to measure the light attenuation resulting from a sample introduced into the capillary. Because light attenuation by the sample will only reduce the intensities of detector elements receiving light from light exit point 174, detector elements that receive light only from walls 175 and 176 can be distinguished. For example, the amount of light reaching columns 201 and 207 would not be attenuated by the presence of a sample component because the light reaching these columns from wall 175 has not propagated through the separation lane of capillary 180.

Some detector elements, such as column 202 may receive light arising both from light exit point 174 and from one of the walls. Although the amount of light reaching column 202 may be attenuated by the presence of sample components, the stray light arising from wall 175 that reaches this column would contribute to absorbance measurement error. Thus, detector signals from columns 202 and 206, which are adjacent columns 201 and 207 that exhibited no attenuation, are preferably excluded from a determination of the amount of light arising from light exit point 174.

After distinguishing detector elements receiving light from walls 175 and 176, only detector elements of columns 203-205 along rows 210 to 217 are used to determine the amount of light propagating between the light entry point and light exit point through the separation lane. A similar process is performed for each light exit point in the array of capillaries.

One way to determine the amount of light attenuation by a sample component is to compare the amount of light that entered the light entry point with the amount of light that entered the separation lane, propagated the separation lane to the light exit point, and exited the separation lane. Because light 183 remains substantially un-attenuated by the presence of a sample in the separation lane, detector signals from column 200 and 201 along rows 210 to 217 is representative of the amount of light that originally entered the light entry point. Thus, detector signals from columns 203-205 can be compared to detector signals from columns 200 and 201 and columns 206 and 207 to determine a sample component absorbance in capillary 180. If the absorbance from a plurality of capillaries is measured, the signal arising from each capillary should be compared with the signal arising from a respective wall of each capillary.

The amount of light that enters each capillary can also be determined by measuring the amount of light that is detected when no samples are present in the separation lane between the light entry point and the light exit point. For example, prior to any samples reaching the light entry point, a first measurement of the light emerging from the light exit point provides an estimate of the light that reached the light entry point. Measurements of the amount of light emerging when a sample component is present in between the light entry and light exit points are compared to the first measurement to determine the attenuation of the light by the sample component. After the sample component has passed beyond the light exit point, another measurement of light emerging from the light exit point can be acquired. This light measurement can also be compared to the light measurements taken with a sample component present to determine the attenuation by the sample component.

An alternative approach for measuring the amount of light that enters each light entry point is to image light reflected from light entry point strip 142 onto an imaging detector, which can be the same detector used to detect light arising from the light exit point strip 144. Each light entry point of light entry point strip 142 is imaged separately so that the light entering a particular capillary can be compared to the light exiting a particular capillary.

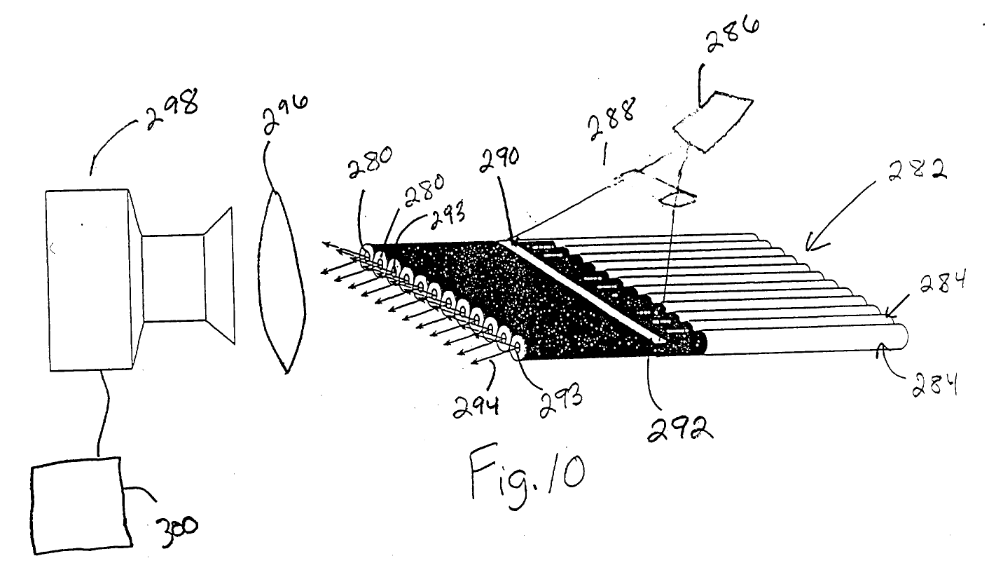

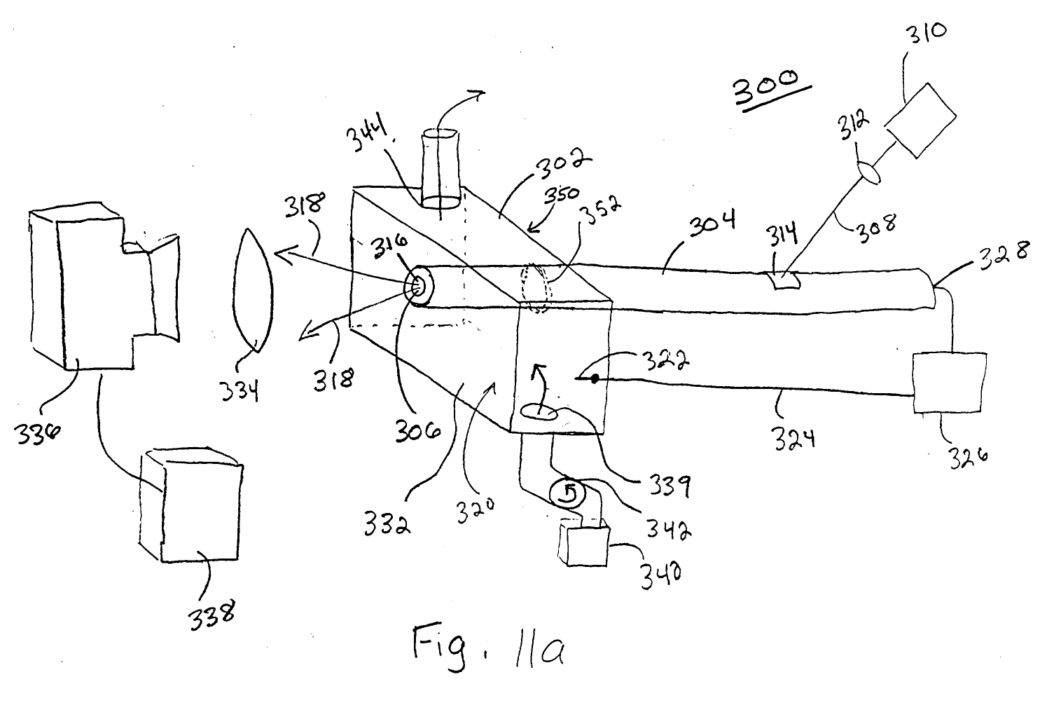

Referring to FIG. 8, yet another approach is shown for obtaining an estimate of the amount of light that reaches each light entry point. The capillaries of a capillary array 900 are spaced apart from one another. For example, a capillary 918 is spaced apart from a capillary 920, preferably by a distance of about 5 to 100 microns. Light 902 from a light source 904 is formed into a shape that matches a light entry strip 906 of array 900. Light 910, 912, 914, and 916 do not enter the separation lanes of array 900 but pass between adjacent capillaries. A lens 922 images light 910, 912, 914, and 916 onto a detector 924 having an array of light sensitive elements, as described above. Light that enters the separation lanes of the capillaries in array 900 emerges from a light exit strip 926. For example, light 921 and light 923 are shown as having emerged from the separation lanes of capillaries 921 and 923, respectively. Light that emerges from each separation lane is also imaged onto detector 924, preferably by the same lens 922. To perform a determination of light attenuation by sample components present in the separation lanes of array 900, detector signals resulting form light that passed between the capillaries are compared to detector signals resulting from light that emerged from a separation lane. For example, detector signals resulting from light 921 are compared to detector signals resulting from light 914 to determine the attenuation of light by sample components present in the separation lane of capillary 920. Because the light 921, 914 are imaged onto different light sensitive elements of detector 924, detector signals resulting from light 921 and 914 can be distinguished as described above. A computer 930 receives and process detector signals from detector 924.

In one embodiment, the detector comprises a wavelength selection device such as a grating or filters to spatially resolve the different wavelengths emerging from the separation lane into a spectrum. A prism, such as a quartz or fused silica prism, is an especially useful wavelength selection device for wavelengths of less than about 300 nanometers. In this configuration, one dimension of the detector, such as the columns, preferably corresponds to capillary number while the other dimension, such as the rows, corresponds to wavelength. Such detector arrangements are seen in U.S. Pat. No. 6,118,127, the contents of which are incorporated herein to the extent necessary to understand the present invention. For each wavelength, detector signals arising from the separation lane are discriminated from detector signals arising from the walls of the separation lane, as described above. In this way, an absorbance spectrum, such as an absorbance spectrum is acquired from each separation lane of the array.

FIG. 8 shows another embodiment of the invention, in which light exiting an end of the separation lane is detected to determine the attenuation by sample components in the separation lane. A capillary 250 includes an end 251 having an opening 252 to a separation lane 253, which is the internal bore of the capillary. Light from a source 256 is focused by a lens 258 to impinge upon a light entry point 254. Light that enters the separation lane propagates toward opening 252. Coating 61 substantially attenuates light that reaches the interface between an exterior surface of capillary 250 and coating 61. Light 258 that exits opening 252 is focused by a lens 260 onto a detector 262 having light sensitive elements, which produce signals depending upon the amount of light received. A computer 264 includes a processor to process the signals.

Referring to FIG. 10, light exiting from ends 280 of an array 282 of capillaries 284 can also be detected to analyze a single sample a plurality of times or to analyze a plurality of samples, as discussed above. Light from a source 286 is focused by a lens 288 onto a light entry point strip 290 formed by light entry points 292 of capillaries 284. Light 294 exiting from openings 293 of capillaries 284 is focused by a lens 296 onto a detector 298, which produces signals that are processed by computer 300.

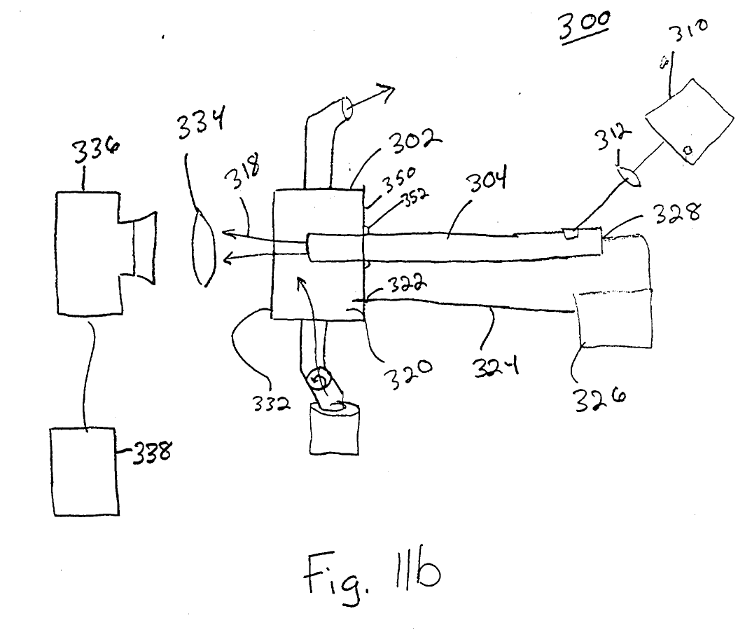

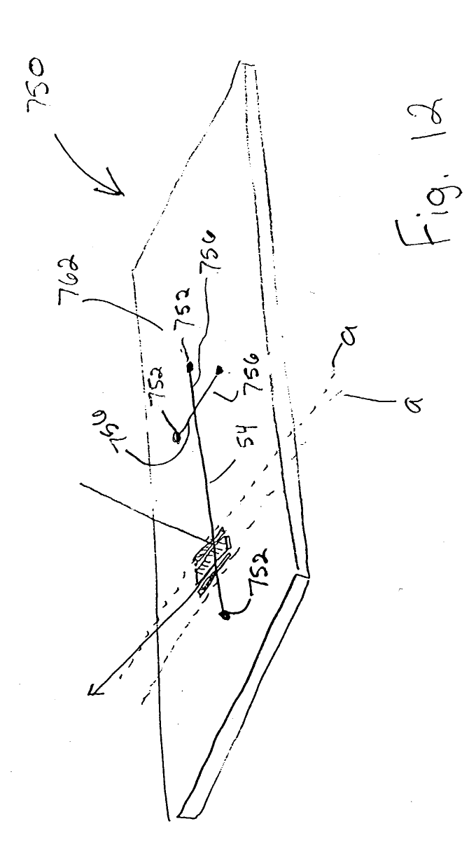

FIGS. 11a and 11b show an embodiment of an apparatus 300 having an optical cell 302 to enhance detection efficiency when light attenuation is measured by detecting light emerging from the end of a separation lane. If optical cell 302 is not present, liquid, such as a running buffer used to support an electrokinetic separation, that exits the end of the separation lane can distort the light rays exiting therefrom. For example, light emerging from the separation lane would pass through drops of liquid forming at the separation lane end. Because the droplets would have a curved time-varying surface, the droplets could distort the direction of focus of the emerging light in an unpredictable way. Optical cell 302 provides an interface that allows light to emerge from the end of the capillary without such unpredictable distortion. Cell 302 also prevents changes in the conductivity of the liquid at the end of the capillary during a separation. Such conductivity changes could be caused by salt deposits left behind by the evaporation of liquid emerging from the capillary end.

A capillary 304 of apparatus 300 has an internal bore 306 that provides a separation lane to support the separation of sample components. A light 308 from a light source 310 is focused by a lens 312 onto a light entry point 314 of capillary 304. After propagating along a longitudinal axis of the capillary, a light 318 exits capillary 304 at an opening 316 and enters cell 302.

The optical cell 302 has a compartment that is preferably filled with a liquid 320, which is preferably the running buffer used to support the separation. An electrical connection 322 provides a connection between liquid 320 and an electrical conductor 324 connected to an electrical power supply 326 used to drive the separation. Power supply 326 is also in electrical contact with a proximal end 328 of capillary 304 to provide a voltage potential sufficient for electrokinetic separations.

At least one face 332 of cell 302 includes a portion formed of optical material, such as silica or quartz, that is optically transparent at a wavelength of the source 310. A second face 350 of cell 302 includes a fitting 352 configured to accommodate capillary 304 without allowing liquid 320 to escape from the cell. Fitting 352 is preferably composed of a polymer. Light 318 exiting opening 316 passes through liquid 320 and through face 332. To ensure that the absorbance of liquid 320 does not change as a result of absorbing sample components reaching cell 302, a flow arrangement is provided to flush separated sample components away. A first port 339 receives liquid 320 from a reservoir 340. A pump 342 can be provided to regulate the introduction of liquid 320 into the cell. Liquid 320 exits cell 302 from a second port 344 to a waste reservoir, which is not shown. The flow rate of liquid is preferably slow enough not to perturb the rate of migration of sample components along the separation lane of capillary 304.

Sample cell 302 can be used with an array of capillaries by configuring second face 352 with a plurality of fittings spaced to accommodate the capillaries of the array. For clarity, only one capillary is shown in FIGS. 10a and 10b.

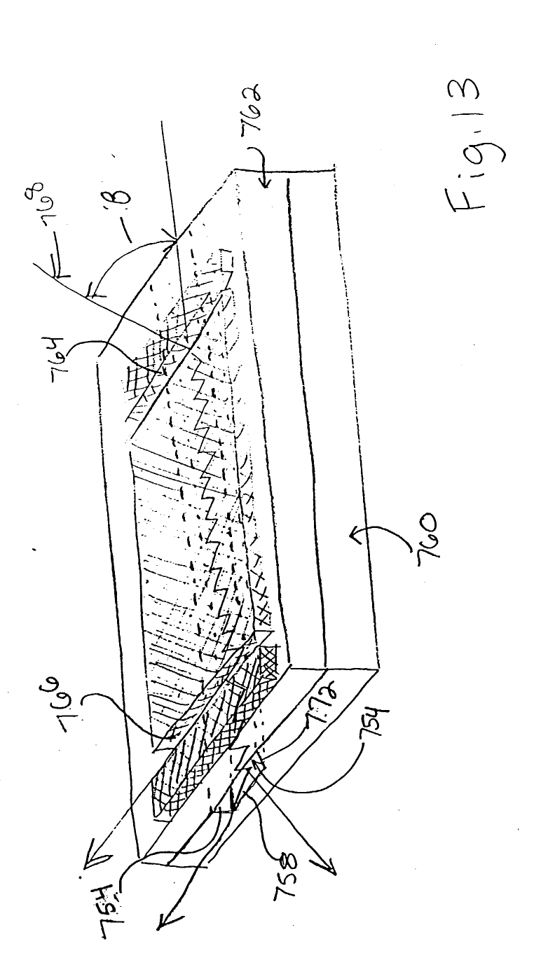

As an alternative to capillaries, microfabricated structures can also be used with the present invention. Referring to FIG. 12, a microfabricated structure 750 preferably has fluid reservoirs 752, a separation channel 754, and auxiliary channels 756 for introducing fluid into the separation channel. A power supply (not shown) is typically electrically associated with at least one of the reservoirs or channels to apply an electric field to the channels such that sample components can be manipulated and/or separated as known in the art.

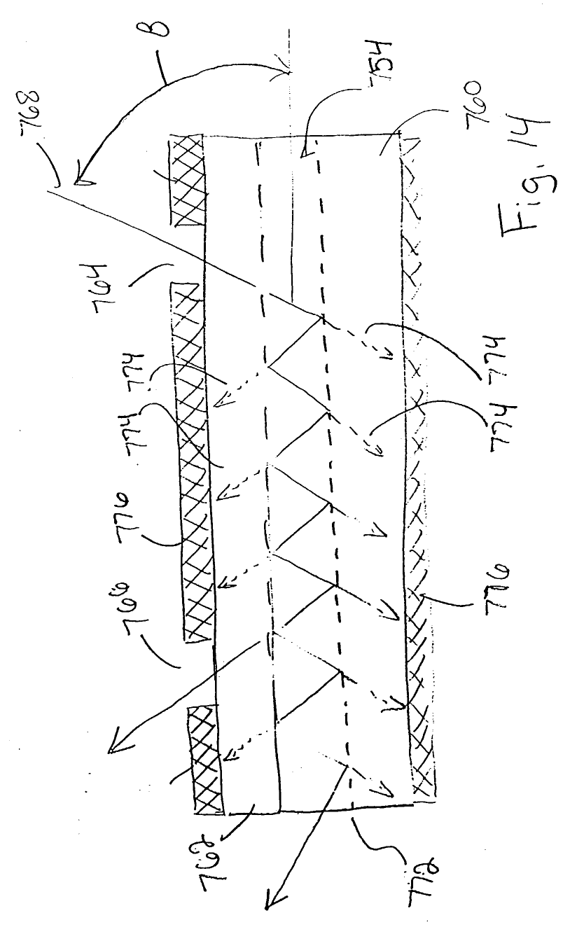

FIG. 13 shows that separation channel 754 preferably comprises a groove 758 in a lower substrate 760. An upper portion of the channel is preferably formed by a lower surface of a cover 762 disposed adjacent substrate 760. Preferably, portions of lower surface of cover and substrate not forming the channel are sufficiently bonded to prevent fluid from migrating therebetween. Substrate 760 and cover 762 are preferably formed of materials suitable for supporting a separation in the presence of an electrical field, such as glass, silica, silicon, and polymers. Additionally, the cover and substrate may be formed of different materials bonded together, as understood in the art.

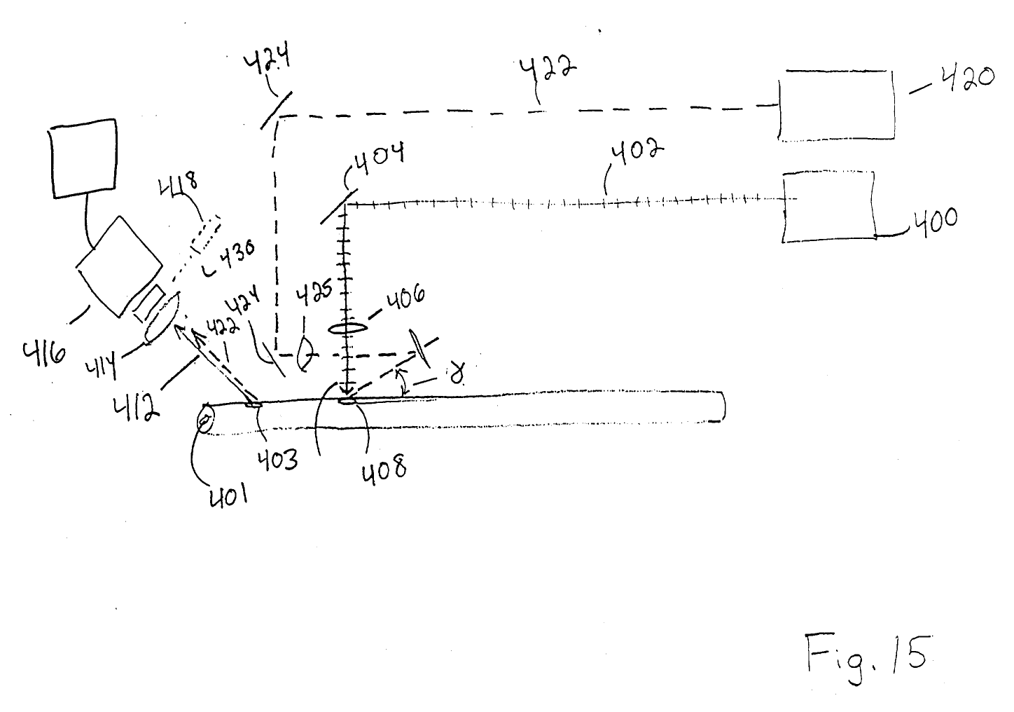

Microfabricated structure 750 includes a light entry point 764 and a light exit point 766 configured to allow light to emerge from channel 754. Light 768 preferably enters the channel at an angle β with respect to channel 754 and preferably propagates along the separation channel toward light exit point 766 as best seen in FIG. 14. Preferably, while propagating down channel, the light changes directions at least twice upon encountering substrate 760 or cover 762. Preferably, each change in direction is caused by an internal reflection. Cover 762 and substrate 760 are preferably configured such that light in the channel, upon encountering light exit point, passes through light exit point to the exterior of channel where it can be detected as discussed below. The microfabricated structure may also be configured such that light exits an exposed end of the channel similar to the exposed end 772.

While propagating along the channel, a portion of the light 774 may pass out of channel upon encountering portions of the cover or substrate disposed apart from light exit point. The cover and/or substrate preferably include a coating 776 or other means, as described above, to prevent such light from reaching the detector. A lens can be used to provide spatial discrimination, as discussed above.

In another embodiment, an apparatus has a first operational mode in which the detector is configured to perform a measurement of sample components based on an attenuation of a light. In a second operational mode the detector is configured to detect at least one of a fluorescence or Raman scattering arising from one or more sample components.

Preferably, the orientation and angle of the light entering the separation channel is different in each operational mode. In the first operational mode, light preferably enters the separation channel at an angle with respect to the separation channel such that the light propagates generally toward the light exit point. In the second operational mode, the light preferably enters the separation channel at an orientation to minimize the amount of the light from the light source that propagates along the channel. Preferably, the light enters perpendicularly to the channel in the second mode. More preferably, a linearly polarized light source, such as a laser, is used in the second mode and the polarization vector of the light lies in substantially the same plane as the longitudinal axis of the separation channel.

Referring to FIG. 15, in the second operational mode, a light source, such as a laser 400, emits a linearly polarized laser beam 402, which is directed by optics such as a mirror 404 and lens 406, toward a light entry point 408. Light emitted or scattered by sample components interacting with laser beam 402 propagates generally along a separation channel 401 toward a light exit point 403. Upon emerging from light exit point 403, emitted or scattered light 412 is incident upon a detector 416. A lens 414 and optical rejection filter 418 to reject the wavelength of the laser beam 402 are preferably placed between the detector and the light exit point 403.

FIG. 14 shows that in the first operational mode a second light source 420, emits a light beam 422 that is directed by optics, such as mirrors 424 and lens 425, toward light entry point 408. Light source 420 may be the same or different from light source 400. Light beam 422 preferably enters the channel at an angle γ with respect to the separation channel to facilitate the light propagating along the channel. Upon emerging from the light exit point 403, light 422, which may have been attenuated by a sample component, is incident upon detector 416. Rejection filter 418 is preferably positioned in out-of-use state 430 to allow light 422 to reach the detector. A computer 450 receives and processes the signals as described above. The apparatus preferably includes a controller and motor to move rejection filter 418 in and out of the light path depending upon the operational mode.

While the above invention has been described with reference to certain preferred embodiments, it should be kept in mind that the scope of the present invention is not limited to these. Thus, one skilled in the art may find variations of these preferred embodiments which, nevertheless, fall within the spirit of the present invention, whose scope is defined by the claims set forth below.

What is claimed is:

1. A separation apparatus for separating components of a sample, comprising:
at least one capillary defining a separation lane having a light entry point and a light exit point spaced apart from the light entry point along a separation direction, the separation lane being suitable for at least partially separating the sample components along the separation direction, a ratio of a longest transverse internal dimension of the separation lane to a minimum transverse internal dimension of the separation lane being less than about 1.2;
a light source configured to emit light suitable to interact with the sample components, light entering the separation lane at the light entry point, with substantially all of the light that enters the separation lane entering at an angle with respect to the separation direction of at least about 20°, the light exiting the separation lane at the light exit point, substantially all of the light exiting at the exit point having passed generally along the separation direction by partial reflections at an internal surface of the separation lane; and
a light detector configured to detect the light exiting the separation lane.

2. The separation apparatus of claim 1, wherein the separation lane, in between the light entry point and the light exit point, is essentially free of particles having a diameter larger than about 25% of a wavelength of the light exiting the separation lane.

3. The separation apparatus of claim 1, wherein the separation lane, in between the light entry point and the light exit point, is essentially free of particles used to support a stationary phase for electro-chromatography.

4. The separation apparatus of claim 3, wherein a ratio of a longest transverse internal dimension of the separation lane to a minimum transverse internal dimension of the separation lane is less than about 1.1.

5. The separation apparatus of claim 4, wherein the separation lane is substantially circular.

6. The separation apparatus of claim 1 further comprising a computer configured to process signals resulting from the light detected by the detector.

7. The separation apparatus of claim 1, wherein the interaction of the light with the sample components in the separation lane attenuates the light and the signals relate to the degree of attenuation.

8. The separation apparatus of claim 7, wherein the emitted light has a plurality of wavelengths and the signals relate to the degree of attenuation of at least two of the emitted wavelengths.

9. The separation apparatus of claim 1, wherein the separation apparatus comprises a plurality of separation lanes and the detector is configured to detect light exiting from respective separation lanes.

10. The separation apparatus of claim 9, wherein at least some light from the light source passes between adjacent separation lanes and is detected by the detector.

11. The separation apparatus of claim 1, wherein the separation lane is the internal bore of the capillary and the separation comprises electrophoresis.

12. The separation apparatus of claim 1, wherein the light, after entering the separation lane, changes direction at least twice before exiting the separation lane.

13. The separation apparatus of claim 1, wherein the separation lane has a minimum internal dimension and a distance between the light entry point and the light exit point is at least about five times greater than the minimum internal dimension.

14. The separation apparatus of claim 1, wherein the distance between the light entry point and the light exit point is from about 0.005 cm to 10 cm.

15. The separation apparatus of claim 1, wherein an effective pathlength Pₑ of the light is at least about 10% greater than a distance separating the light entry point and light exit point.

16. The separation apparatus of claim 1, wherein a distance between the light entry point and the light exit point is at least about 5 times greater than an internal diameter of the separation lane.

17. A separation apparatus for separating components of a sample, comprising:
at least one capillary defining a separation lane having a light entry point and a light exit point spaced apart from the light entry point along a separation direction, the separation lane being suitable for at least partially separating the sample components along the separation direction, a ratio of a longest transverse internal dimension of the separation lane to a minimum transverse internal dimension of the separation lane being less than about 1.2;
a light source configured to emit light suitable to interact with the sample components, the light entering the internal bore at the a light entry point, the light exiting the internal bore at a light exit point, substantially all of the light exiting at the exit point having passed generally along the separation direction by partial reflections at an internal surface of the separation lane and, wherein the internal bore, in between the light entry point and the light exit point, is essentially free of particles having a diameter larger than about 50% of a wavelength of the light exiting the internal bore; and
a light detector configured to detect the light exiting the internal bore.

18. The separation apparatus of claim 17, wherein substantially all of the light that enters the internal bore enters at an angle of at least about 20° with respect to the separation direction.

19. The separation apparatus of claim 17, wherein the internal bore, in between the light entry point and the light exit point, is essentially free of particles.

20. The separation apparatus of claim 17, wherein the interaction of the light with the sample components in the separation lane attenuates the light and the signals relate to the degree of attenuation.

21. The separation apparatus of claim 17, wherein an effective pathlength Pₑ within the separation lane of the light is at least about 10% greater than a distance separating the light entry point and light exit point.

22. The separation apparatus of claim 17, wherein a distance between the light entry point and the light exit point is at least about 5 times greater than an internal diameter of the separation lane.

23. A separation apparatus for separating components of a sample, comprising:
at least one capillary having an internal bore defining a separation lane having a light entry point and a light exit point spaced apart from the light entry point along a separation direction, the separation lane being suitable for at least partially separating the sample components along the separation direction;
a light source configured to emit light suitable to interact with the sample components, light entering the separation lane at the light entry point therealong, the light exiting the separation lane at the light exit point, substantially all of the light exiting at the exit point having passed generally along the separation direction by partial reflections at an internal surface of the separation lane and, wherein the longitudinal axis is substantially straight between a first point upstream of the light entry point and a second point downstream of the light entry point, and further wherein the separation bore, in between the light entry point and the light exit point, is essentially free of particles having a diameter larger than about 50% of a wavelength of the light exiting the separation lane; and
a light detector configured to detect the light exiting the separation lane.

24. The separation apparatus of claim 23 wherein the upstream point is disposed less than about 5 mm upstream from the light entry point.

25. The separation apparatus of claim 23 wherein an angle between the upstream and downstream points is at least about 100°.

26. The separation apparatus of claim 23 wherein the interaction of the light with the sample components in the separation lane attenuates the light and the signals relate to the degree of attenuation.

27. The separation apparatus of claim 23 wherein the separation lane is substantially circular.

28. The separation apparatus of claim 23, wherein a distance between the light entry point and the light exit point is at least about 5 times greater than an internal diameter of the separation lane.

29. An apparatus for processing signals indicative of a separation of components of a sample, the components having been at least partially separated along a separation lane of a capillary, the separation lane having a separation direction, an amount of light from a light source entering the separation lane at a light entry point therealong, the light exiting the separation lane at a light exit point that is spaced apart from the light entry point along the separation direction, substantially all of the light exiting at the exit point having passed generally along the separation direction by partial reflections at an internal surface of the separation lane, the apparatus comprising:
a processor configured to receive a plurality signals from a detector, a first portion of the signals resulting from the light that exited the separation lane, a second portion of the detector signals resulting from light that is indicative of the amount of light that entered the separation lane, wherein the processor is configured to distinguish between the first and second detector signals.

30. The apparatus of claim 29, wherein the light exited the separation lane was attenuated by at least one sample component therein.

31. The apparatus of claim 29, wherein the light that is indicative of the amount of light that entered the separation lane has propagated along the separation direction through a wall of the capillary.

32. The apparatus of claim 29, wherein the interaction of the light with the sample components in the separation lane attenuates the light and the signals relate to the degree of attenuation.

33. The apparatus of claim 29, wherein the separation lane, in between the light entry point and the light exit point, is essentially free of particles having a diameter larger than about 25% of a wavelength of the light exiting the separation lane.

34. The apparatus of claim 29, wherein substantially all of the light that entered the separation lane entered at an angle with respect to the separation direction of at least about 20°.

35. The apparatus of claim 29, wherein an effective pathlength Pₑ of the light is at least about 10% greater than a distance separating the light entry point and light exit point.

36. A separation apparatus for separating components of a sample, comprising:
at least one capillary defining a separation lane suitable for at least partially separating the sample components along a separation direction;
a light source configured to emit light suitable to interact with the sample components, light entering the separation lane at a light entry point therealong, the light exiting the separation lane from an end of the separation lane, the end of the separation lane being spaced apart from the light entry point along the separation direction; and
a light detector configured to detect the light exiting the separation lane.

37. The separation apparatus of claim 36, further comprising an optical cell optically associated with the end of the separation lane, the optical cell being configured to maintain a fluid in contact with the end of the separation lane to provide an optical path for light to pass from the end separation lane toward the detector.

38. The separation apparatus of claim 37, wherein the interaction of the light with the sample components in the separation lane attenuates the light and the signals relate to the degree of attenuation.

39. The separation apparatus of claim 36, wherein an effective pathlength Pₑ of the light is at least about 10% greater than a distance separating the light entry point and light exit point.

40. A method for separating components of a sample, comprising:
directing light into a substantially circular separation lane of a capillary at a light entry point of the separation lane, the separation lane being suitable for at least partially separating the sample components along a separation dimension, wherein substantially all of the light that enters the separation lane enters at an angle of at least about 20° with respect to the separation direction, at least some of the light that enters the separation lane exiting the separation lane at a light exit point, substantially all of the light exiting at the exit point having passed generally along the separation direction by partial reflections at a substantially circular internal surface of the separation lane, the light exit point spaced apart from the light entry point along the separation lane;
directing the light that exits the separation lane onto a detector; and
determining an attenuation of the light that exits the separation lane.

41. The method of claim 40, wherein a distance between the light entry point and light exit point is at least about 5 times greater than an internal diameter of the separation lane.

42. A separation apparatus for separating components of a sample, comprising:
at least one capillary defining a separation lane having a light entry point and a light exit point spaced apart from the light entry point along a separation direction, the separation lane being suitable for at least partially separating the sample components along the separation direction, the capillary having an exterior surface disposed between the light entry point and light exit point, the exterior surface being in optical communication with a coating to attenuate light impinging upon the exterior surface, an outer surface of the capillary between the light entry and exit points being optically associated with a material that prevents light passing from the separation lane to the outer surface of the capillary from reaching the detector;
a light source configured to emit light suitable to interact with the sample components, light entering the separation lane at the light entry point, with substantially all of the light that enters the separation lane entering at an angle with respect to the separation direction of at least about 20°, the light exiting the separation lane at the light exit point, substantially all of the light exiting at the exit point having passed generally along the separation direction by partial reflections at an internal surface of the separation lane; and
a light detector configured to detect the light exiting the separation lane.

43. The separation apparatus of claim 1, wherein an outer surface of the capillary between the light entry and exit points is optically associated with a material that prevents light passing from the separation lane to the outer surface of the capillary from reaching the detector.

44. The separation apparatus of claim 1, wherein substantially all of the light that enters the separation lane enters at an angle with respect to the separation direction of less than about 70°.

45. The separation apparatus of claim 17, wherein an outer surface of the capillary between the light entry and exit points is optically associated with a material that prevents light passing from the separation lane to the outer surface of the capillary from reaching the detector.

46. The separation apparatus of claim 17, wherein substantially all of the light that enters the separation lane enters at an angle with respect to the separation direction of less than about 70°.

47. The separation apparatus of claim 23, wherein an outer surface of the capillary between the light entry and exit points is optically associated with a material that prevents light passing from the separation lane to the outer surface of the capillary from reaching the detector.

48. The separation apparatus of claim 23, wherein substantially all of the light that enters the separation lane enters at an angle with respect to the separation direction of less than about 70°.

49. The separation apparatus of claim 29, wherein an outer surface of the capillary between the light entry and exit points is optically associated with a material that prevents light passing from the separation lane to the outer surface of the capillary from reaching the detector.

50. The separation apparatus of claim 29, wherein substantially all of the light that enters the separation lane enters at an angle with respect to the separation direction of less than about 70°.

51. The separation apparatus of claim 40, wherein an outer surface of the capillary between the light entry and exit points is optically associated with a material that prevents light passing from the separation lane to the outer surface of the capillary from reaching the detector.

52. The separation apparatus of claim 40, wherein substantially all of the light that enters the separation lane enters at an angle with respect to the separation direction of less than about 70°.

54. The separation apparatus of claim 42, wherein substantially all of the light that enters the separation lane enters at an angle with respect to the separation direction of less than about 70°.
